(19) United States
(12) Patent Application Publication
(10) Pub. No.: US 2015/0280426 A1
(43) Pub. Date: Oct. 1, 2015

(54) RELAY PROTECTOR DEVICE AND OPERATION METHOD FOR THE SAME

(71) Applicant: IR-TEC INTERNATIONAL LTD., Taoyuan County (TW)

(72) Inventor: WEN-I HUANG, TAOYUAN COUNTY (TW)

(73) Assignee: IR-TEC INTERNATIONAL LTD., Taoyuan County (TW)

(21) Appl. No.: 14/231,759

(22) Filed: Apr. 1, 2014

(51) Int. Cl. H02H 9/02

(52) U.S. Cl. CPC H02H 9/02

(57) ABSTRACT

A relay protector device is provided, mitigating the impact of the inrush current to a circuit and comprising a relay circuit; a driver circuit, connecting in parallel with the relay circuit; and a controller, connecting through a signal to the relay circuit and the driver circuit and being driven by a driving signal to trigger in sequence the relay circuit and the driver circuit to operate.

### (a) TECHNICAL FIELD OF THE INVENTION

This invention relates to a relay protector device mitigating the impact of inrush current and particularly to a relay protector device available for electronic products or household electronic appliances, such as air conditioners, TV sets and the like, and method for the same.

### (b) DESCRIPTION OF THE PRIOR ART

An electronic device is required to work with a protector circuit because each electronic device consumes its own power and operates with its own voltage and current. In the condition of unigauge power supply, to avoid the voltage or current of the power supply from damaging the electronic device, the protector circuit must be designed in to make the electronic device operate normally. The means of voltage-based protection comprises a regular voltage or variable voltage circuit design, while the means of current-based protection comprises a limited current or rectifier circuit design. Accordingly, the protector circuit prevents the voltage or current of the normal power supply from damaging the electronic device.

Generally, the electronic device is designed with a resistor-capacitor (RC) or resistor-inductor (RL) circuit. When the electronic device is suddenly powered, its RC or RL circuit is transiently short or open, which easily causes the irush current doing damage to the electronic device. Thus, a protection circuit for power switch must be designed in. A relay is widely used as a protector member for power switch. The relay is a device as a switch controlling the current, being characterized with input loop control and output loop control; that is, when the input coil of the relay is powered, the relay's output contact turns ON. Thus, the relay is widely used in an automatic control circuit. Besides, being featured with an automatic switch that uses its small current signal to drive a large-current electronic device, so the relay is generally used in a delay-action switch circuit design for mitigating the impact of inrush current caused to the electronic device that is suddenly powered.

Consequently, because of the technical defects of described above, the applicant keeps on carving unflaggingly through wholehearted experience and research to develop the present invention, which can effectively improve the defects described above.

### SUMMARY OF THE INVENTION

A relay protector device according to this invention, particularly mitigating the impact of the inrush current to an electronic product, comprises a relay circuit; a driver circuit, connecting in parallel with the relay circuit; and a controller, connecting through a signal to the relay circuit and the driver circuit and being driven by a driving signal to trigger in sequence the relay circuit and the driver circuit to operate for the effect of protection.

The relay protector device according to this invention is provided to mitigating the impact of inrush current by using a driver circuit working with a relay circuit for circuit protection. If an electronic device works with a single relay circuit to mitigate the impact of inrush current, the effect of mitigation depends on the speed of response and launch of the relay circuit. When the instantaneous short of the RC circuit does not end, if the response of the relay circuit startup is very slow and the material for the relay cannot properly mitigate the impact of inrush current, the inrush current still probably damages the electronic device. The relay protector device according to this invention is provided with a driver circuit connected in parallel with a relay circuit. When the inrush current occurs, a controller that is arranged transmits a driving signal to enable in advance the driver circuit for protection and then transmits another driving signal to enable the relay circuit. The relay protector device according to this invention significantly may decrease the probability of the impact of inrush current to the electronic device and also may lower the extent of impairment of the relay.

### BRIEF DESCRIPTION OF THE DRAWINGS

FIG. 1 is a circuit diagram of a relay protector device according to this invention.

FIG. 2 is a circuit diagram of a relay protector device provided with a zero-crossing circuit.

FIG. 3 is a timing diagram of operation of a controller for enabling the relay protector device.

FIG. 4 is a timing diagram of operation of the controller for disabling the relay protector device.

FIG. 5 is a timing diagram of operation of a controller having a zero-crossing signal for enabling for enabling the relay protector device.

FIG. 6 is a timing diagram of operation of a controller having a zero-crossing signal for enabling for disabling the relay protector device.

FIG. 7 is a schematic view illustrating the circuit of relay protector device in a first embodiment of this invention.

FIG. 8 is a schematic view illustrating the circuit of relay protector device in a second embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

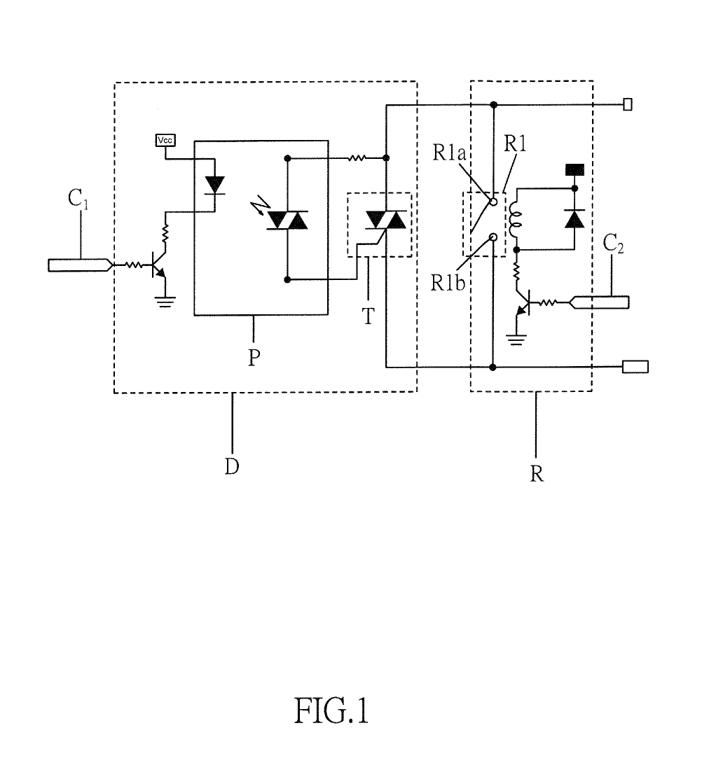

With reference to FIG. 1 as a circuit diagram of a relay protector device according to this invention, the relay protector device comprises: a relay circuit R, a driver circuit D connected in parallel with the relay circuit R, and a controller. The driver circuit D is connected in parallel with the relay circuit R. The driver circuit D and the relay circuit R are provided respectively with a driving signal terminal C₁ and a diving signal terminal C₂ for the controller to signal to. The controller transmits a driving signal to enable in sequence the driver circuit D and the relay circuit R. In the relay protector device according to this invention, the driver circuit D further comprises a circuit in which a photo coupler device P and a TRIAC device T are arranged. The photo coupler device P is connected in parallel with the TRIAC device T to control the TRIAC device T. The relay circuit R is a relay unit provided with an electromagnetic relay and a diode.

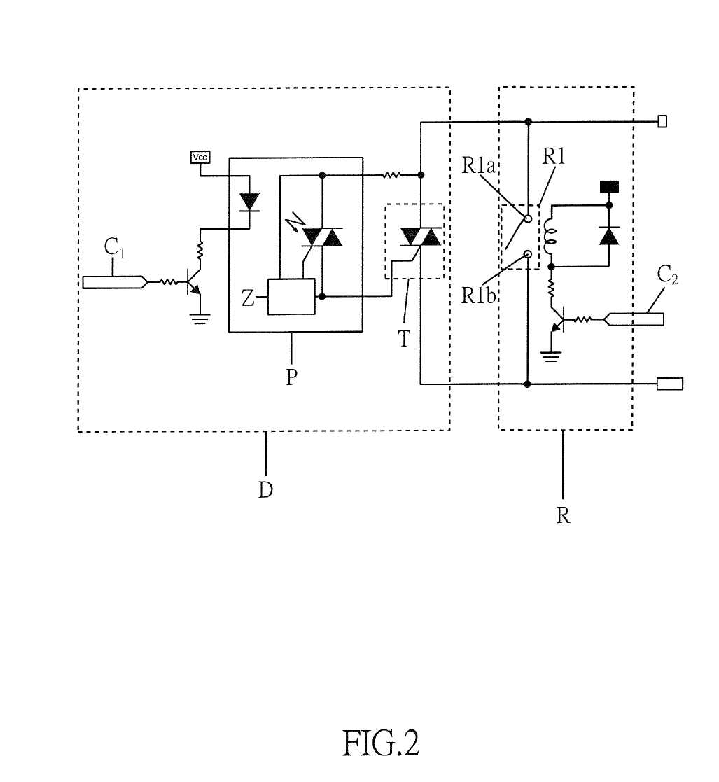

With reference to FIG. 2 as a circuit diagram of a relay protector device according to this invention, the relay protector device comprises a driver circuit D connected in parallel with a relay circuit R. The driver circuit D and the relay circuit R are provided respectively with a driving signal terminal C₁ and a diving signal terminal C₂ for a controller to signal to. The controller transmits a driving signal to enable in sequence the driver circuit D and the relay circuit R. In the relay protector device according to this invention, the driver circuit D further comprises a circuit in which a photo coupler device P and a TRIAC device T are arranged. The photo coupler device P is connected in parallel with the TRIAC device T to control the TRIAC device T. Further, the photo coupler device P is designed with a zero-crossing circuit Z that is used to correct the zero-crossing signal of AC power.

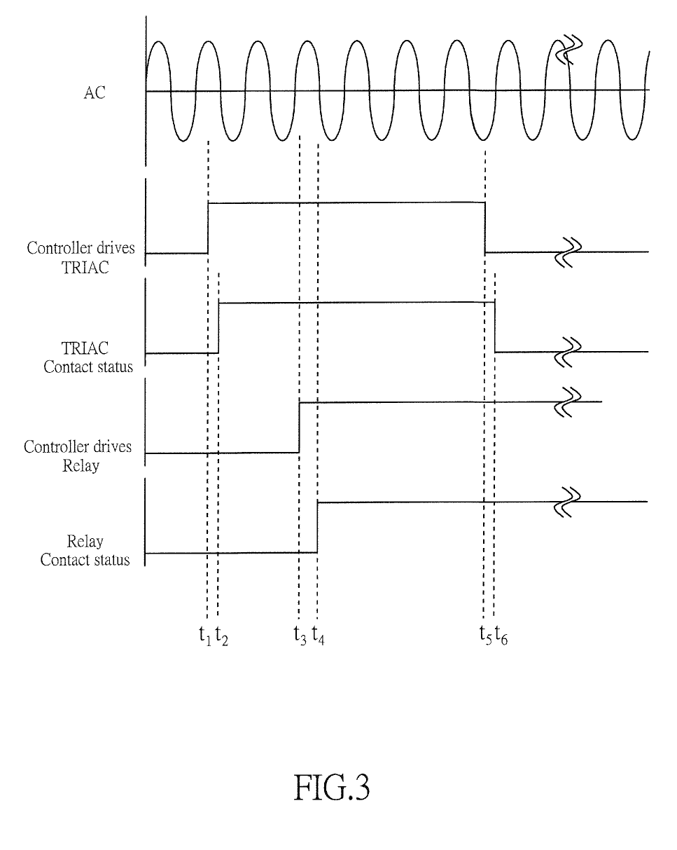

Refer to FIG. 3 as a timing diagram of operation of the controller for enabling the relay protector device. It is characterized that the driver circuit D firstly operates and then the relay circuit R works. Refer to FIGS. 2 and 3 at the same time. At t₁, the controller inputs a driving signal from a driving signal terminal C₁ to enable the driver circuit D, and with the photo coupler device P that enables the TRIAC device T at t₂, the impact of inrush current is mitigated. At t₃, the controller inputs another driving signal from a driving signal terminal C₂ to enable the relay circuit R. At t₄, the relay works. Then, at t₅, the controller stops signaling from the driving signal terminal C₁. With the photo coupler device P that disables the TRIAC device T at t₆, the impact of inrush current to the relay circuit R is mitigated.

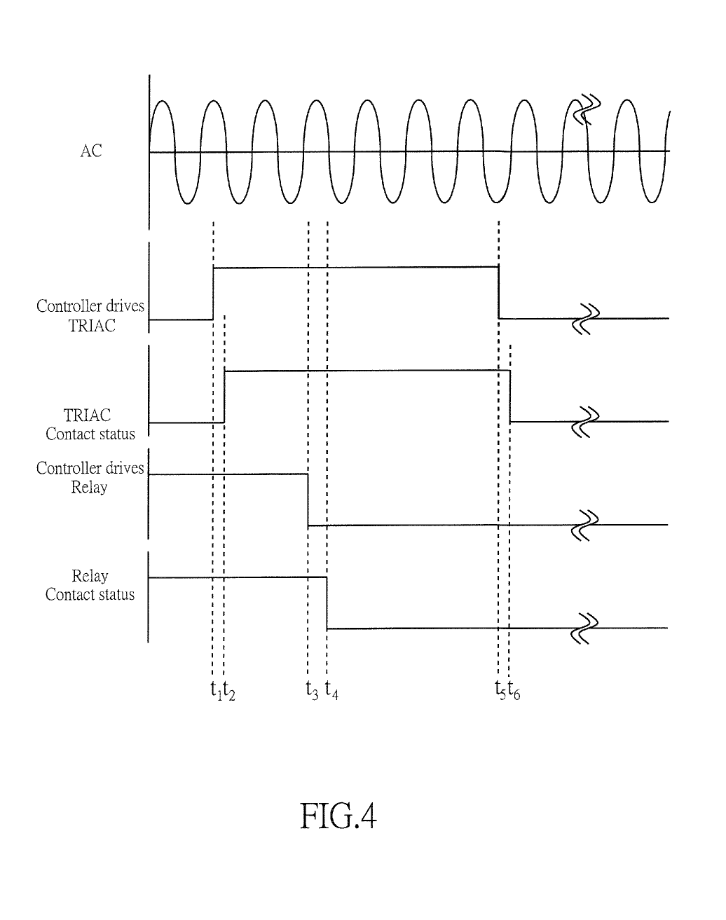

Refer to FIG. 4 as a timing diagram of operation of the controller for disabling the relay protector device. It is characterized that the relay circuit R firstly stop operating and then the driver circuit D stop working. Refer to FIGS. 2 and 4 at the same time. At t₁, the controller inputs another driving signal from a driving signal terminal C₁ to enable the driver circuit D. With the photo coupler device P that enables the TRIAC device T at t₂, the impact of inrush current is mitigated. At t₃, the controller inputs another driving signal from the driving signal terminal C₂. At t₄, the relay works. At t₅, the controller stops signaling from the driving signal terminal C₁ and thus the driver circuit D is disabled. At t₆, the TRIAC device T stop working and the inrush current is mitigated, the relay protector device thereby stopping working.

Refer to FIG. 2 as the circuit diagram of relay protector device according to this invention. The driver circuit D is designed with a zero-crossing circuit Z that is used to correct the zero-crossing signal of AC power. In case of arrangement of no zero-crossing circuit Z, the relay protector device needs to depend on the controller that corrects the zero-crossing signal of AC power.

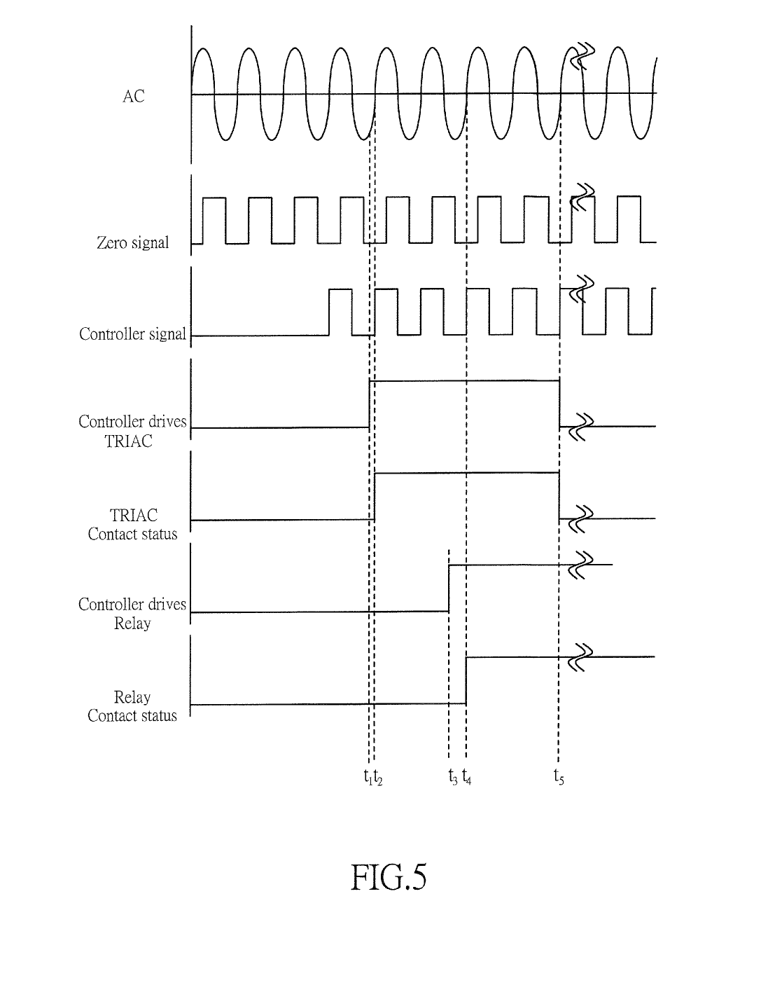

Refer to FIG. 5 as a timing diagram of operation of a controller having a zero-crossing signal for enabling for enabling the relay protector device. At t₁, calculating the timing of zero signal, the controller, inputs a driving signal from the driving signal terminal C₁ to enable the driver circuit D. At t₂, time of zero signal, the TRIAC device T is enabled. At t₃, the controller inputs another driving signal from the driving signal terminal C₂. At t₄, time of zero signal, the relay circuit R stops working. At t₅, the controller stops signaling from the driving signal terminal C₁ and the TRIAC device T stop working. Accordingly, the impact of inrush current may be mitigated.

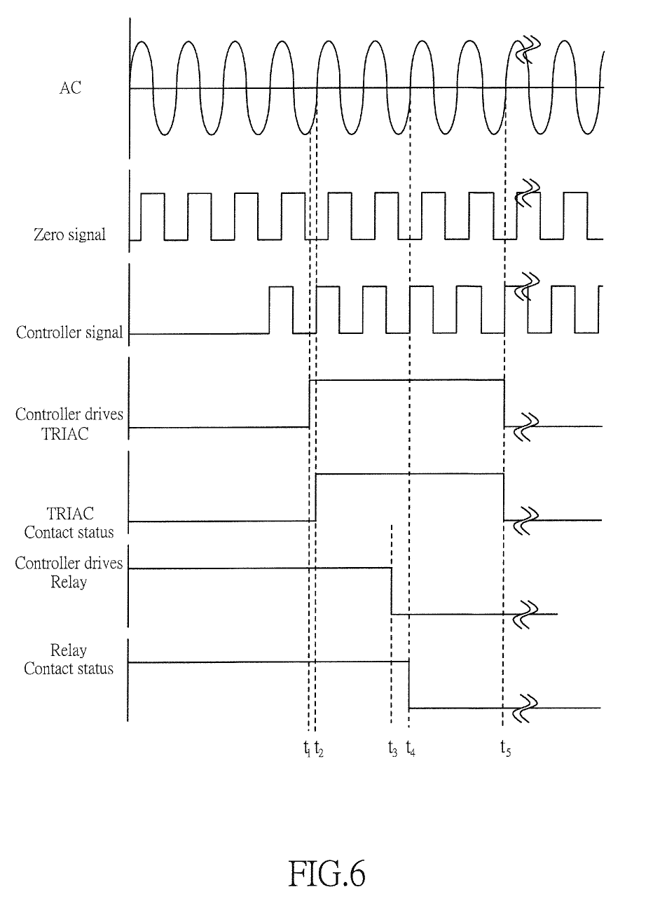

In case of arrangement of no zero-crossing circuit Z in the photo coupler device of the relay protector device, the relay protector device needs to depend on the controller that corrects the zero-crossing signal of AC power. Alternatively, a zero-crossing circuit that may detect the zero-crossing signal is further added to the AC power terminal in another manner to transmit the detected zero-crossing signal to the controller for enabling or disabling the photo coupler TO control the TRIAC. Refer to FIG. 6 as a timing diagram of operation of a controller having a zero-crossing signal for enabling for disabling the relay protector device. At t₁, calculating the timing of zero signal, the controller, inputs a driving signal from the driving signal terminal C₁ to enable the driver circuit D. At t₂, time of zero signal, the TRIAC device T is enabled. At t₃, the controller inputs another driving signal from the driving signal terminal C₂. At t₄, time of zero signal, the relay circuit R stops working. At t₅, the controller stops signaling from the driving signal terminal C₁ and the TRIAC device T stop working. Accordingly, the impact of inrush current may be mitigated. Thus, from FIGS. 5 and 6 that illustrate the timing diagram, it is known that the design of zero-crossing circuit Z helps the relay protection device to operate.

From the description made above, the relay protection device not only may protect the relay circuit R but may protect the contacts R1a and R1b of switch R1 of the relay to mitigate the impact of inrush current formed in the circuit.

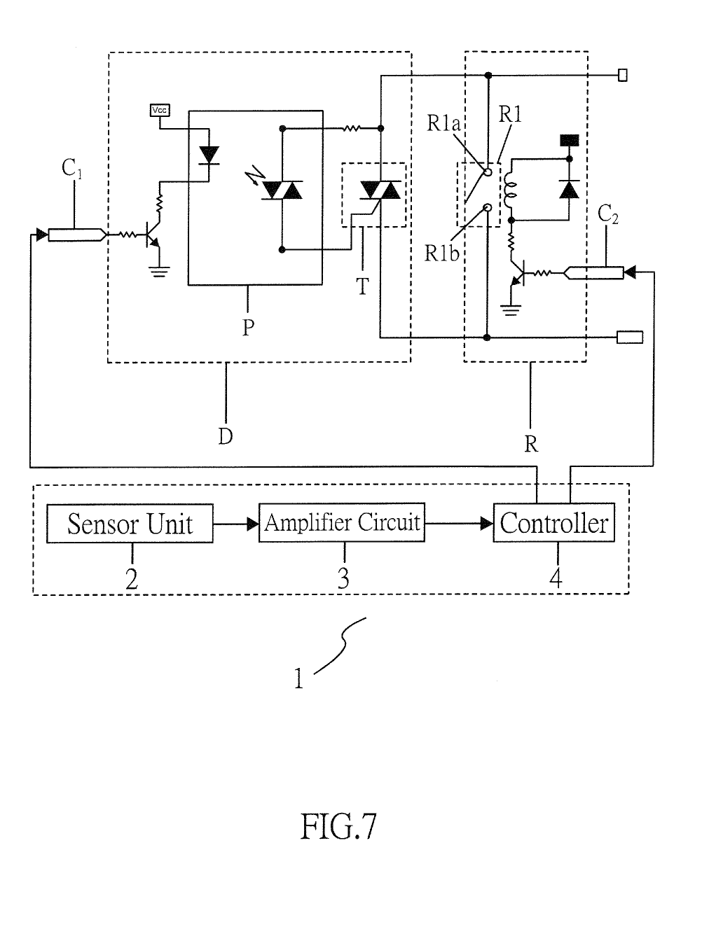

Refer to FIG. 7 as a schematic view illustrating the circuit of relay protector device in a first embodiment of this invention. The relay circuit is further designed in a sensor device 1, in which the sensor device 1 a wall-hanging sensor device or a ceiling sensor device. The sensor device 1 comprises a sensor unit 2, an amplifier circuit 3, and a controller 4. When the sensor unit 2 in the sensor device 1 detects a person or vehicle moving in a sensitive range, the sensor unit 2 transmits a signal to the controller 4. Here, the controller 4 thereby transmits a driving signal to the driving signal terminal C₁ for making the TRIAC device turn ON for a period of time, and then transmits a driving signal to the driving signal terminal C₂. Here, the relay turns ON. After the relay turns ON for a period of time, the controller 4 transmits a driving signal to the driving signal terminal C₁, making the TRIAC device stop working.

When the sensor unit 2 in the sensor device 1 detects neither person nor vehicle moving in the sensitive range, the sensor unit 2 transmits a signal to the controller 4. Here, the controller 4 thereby transmits a driving signal to the driving signal terminal C₁ for making the TRIAC device turn ON for a period of time, and then transmits a driving signal to the driving signal terminal C₂. Here, the relay is made to turn OFF. After the relay turns OFF for a period of time, the controller 4 transmits a driving signal to the driving signal terminal C₁, making the TRIAC device stop working.

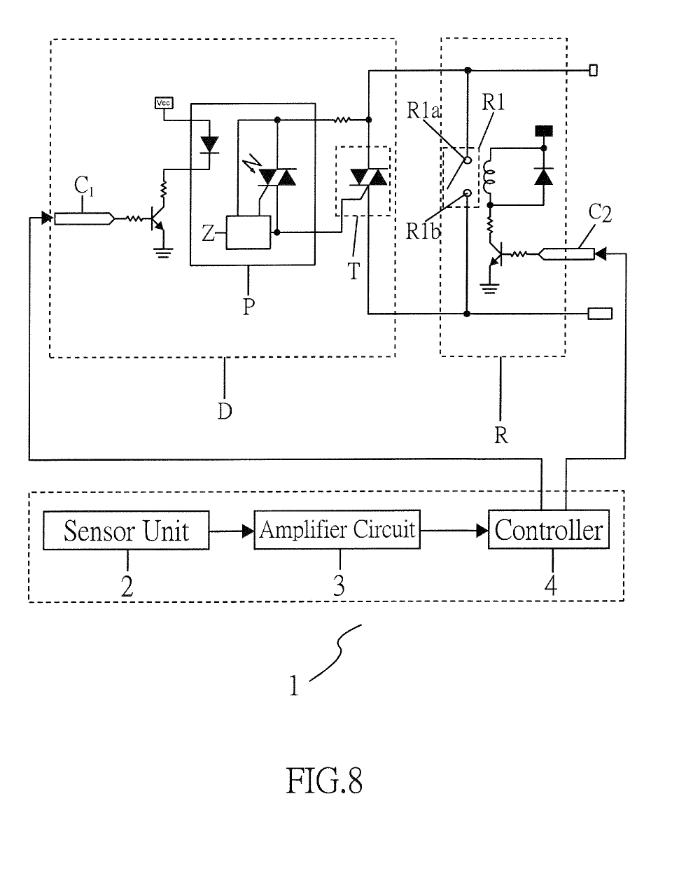

Refer to FIG. 8 as a schematic view illustrating the circuit of relay protector device in a second embodiment of this invention. The relay circuit is further designed in the sensor device 1 and the zero-crossing circuit Z is further designed in, in which the sensor device 1 a wall-hanging sensor device or a ceiling sensor device. The sensor device 1 comprises a sensor unit 2, an amplifier circuit 3, and a controller 4. When the sensor unit 2 in the sensor device 1 detects a person or vehicle moving in a sensitive range, the sensor unit 2 transmits a signal to the controller 4. Here, the controller 4 thereby transmits a driving signal to the driving signal terminal C₁ for making the TRIAC device turn ON for a period of time, and then transmits a driving signal to the driving signal terminal C₂. Here, the relay turns ON. After the relay turns ON for a period of time, the controller 4 transmits a driving signal to the driving signal terminal C₁, making the TRIAC device stop working.

When the sensor unit 2 in the sensor device 1 detects neither person nor vehicle moving in a sensitive range, the sensor unit 2 transmits a signal to the controller 4. Here, the controller 4 thereby transmits a driving signal to the driving signal terminal C₁ for making the TRIAC device turn ON for a period of time, and then transmits a driving signal to the driving signal terminal C₂. Here, the relay is made to turn OFF. After the relay turns OFF for a period of time, the controller 4 transmits a driving signal to the driving signal terminal C₁, making the TRIAC device stop working.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

I claim:

1. A relay protector device, being used to mitigate the impact of inrush current in a circuit to a relay and comprising:
a relay circuit;
a driver circuit, being connected in parallel with the relay circuit; and
a controller, connecting through a signal to the relay circuit and the driver circuit and being driven by a driving signal to trigger in sequence the relay circuit and the driver circuit.

2. The relay protector device according to claim 1, wherein the driver circuit further comprises a circuit in which a photo coupler device and a TRIAC device are arranged.

3. The relay protector device according to claim 2, wherein the photo coupler device and the TRIAC device are members further protecting the contacts of switch of the relay.

4. The relay protector device according to claim 2, wherein the photo coupler device is provided with a zero-crossing circuit.

5. The relay protector device according to claim 4, wherein In case of arrangement of no zero-crossing circuit, a zero-crossing circuit is further added to the AC power terminal in another manner to transmit the detected zero-crossing signal to the controller for enabling or disabling the photo coupler to control the TRIAC.

6. The relay protector device according to claim 1, wherein the relay circuit is further designed in a sensor device.

7. The relay protector device according to claim 6, wherein the sensor device a wall-hanging sensor device or a celling sensor device.

8. The relay protector device according to claim 6, wherein the sensor device comprises a sensor unit, an amplifier circuit, and a controller.

9. A method for operation of a relay protector device, comprising enabling the relay protector device by a controller and disabling the relay protector device by the controller.

10. The method for operation of the relay protector device according to claim 9, wherein enabling the relay protector device by the controller comprise steps of:
making the driver circuit firstly operate and then the relay circuit work;
at t₁, making the controller input a driving signal from a driving signal terminal to enable the driver circuit;
with the photo coupler device that enables the TRIAC device at t₂, mitigating the impact of inrush current;
at t₃, making the controller input another driving signal from another driving signal terminal to enable the relay circuit, and at t₄, making the relay work;
at t₅, making the controller stop signaling from the driving signal terminal; and
with the photo coupler, making the TRIAC device stop working at t₆ and making only the relay circuit output current.

11. The method for operation of the relay protector device according to claim 9, wherein disabling the relay protector device by the controller comprise steps of:
making the driver circuit firstly stop operating and then the relay circuit stop working;
at t₁, making the controller input a driving signal from a driving signal terminal to enable the driver circuit;
with the photo coupler device, enabling the TRIAC device at t₂;
at t₃, making the controller input another driving signal from another driving signal terminal;
at t₄, making the relay work;
at t₅, making the controller stop signaling from the driving signal terminal and further disabling the driver circuit; and
at t₆, making the TRIAC device stop working for mitigating the inrush current and stopping the relay protector device working.
